(19) United States
(12) Patent Application Publication
(10) Pub. No.: US 2005/0083688 A1
(43) Pub. Date: Apr. 21, 2005

(54) Luminaire for emitting light having a variable color

(76) Inventors: Norbert Dicken, Eindhoven (NL); Maarten De Leuw, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,664

(22) PCT Filed: Feb. 5, 2003
(86) PCT No.: PCT/IB03/00480

(30) Foreign Application Priority Data
Feb. 21, 2002 (EP) 02075662.3
Oct. 16, 2002 (EP) 02079275.0

(51) Int. Cl. F21V 1/00; F21V 11/00

(52) U.S. Cl. 362/235; 313/110; 362/246

(57) ABSTRACT

Luminaire comprising at least two lamps (6,7,8) and a light reflecting surface (23) reflecting the light from said lamps. the lamps (6,7,8) radiate light with different colors. The intensity of the light shining from a lamp can be reduced in order to vary the color of the light. The light shines through a diffuser plate (10) forming the front side of the luminaire. A light curtain plate (22) is located between the lamps (6,7,8) and the diffuser plate (10). the light curtain plate (22) contains light reflecting material.

The invention is related to a luminaire comprising holders for at least two lamps and a light reflecting surface for reflecting the light from said lamps, the lamps may radiate light with different colors, whereby the intensity of the light shining from a lamp can be reduced in order to vary the color of the light shining through a diffuser plate forming the front side of the luminaire. The luminaire may comprise the at least two lamps, but can also be stored and sold without the lamps.

Such luminaire can be provided with a flat front surface formed by the diffuser plate, whereby soft diffuse light—shining from the luminaire—is equally distributed over said front surface. By positioning a number of such luminaires next to each other, a lighting surface is created. For example, the lighting surface can be used as ceiling or portion of a ceiling, or as vertical wall or portion of such wall, for lighting a shop area or the like.

By making use of a group of lamps having different colors, the color of the mixed light shining from the luminaire is depending on the light intensity of each of the lamps of the group. The mixed light can be varied by reducing the light intensity of one or more lamps of said group of lamps.

Although the luminaire contains lamps of different color, the light shining from the luminaire should be sufficiently mixed to avoid any impression that lamps of different colors are present inside the luminaire.

The object of the invention is to provide a luminaire whereby the mixing of light originating from lamps of different colors is improved.

In order to accomplish that objective, a light curtain plate is located between the location of the lamps and the diffuser plate, whereby the light curtain plate contains light reflecting material. Therefore the light curtain plate reflects a substantial portion of the light, so that it can be reflected again by the light reflecting surface for further scattering, to increase the mixing of the light, whereby the light becomes homogeneously spread in the volume of the luminaire. The portion of the light being transmitted by the light curtain plate reaches the diffuser plate. Also the diffuser plate can contain reflecting material, so that again a portion of the light is sent back into the luminaire for further scattering.

Preferably, the light curtain plate is substantial parallel to the diffuser plate. In one preferred embodiment the light curtain plate is transparent and provided with a coating containing high reflecting pigment. The pigment may be of inorganic material and the transparent binder of the coating may be of organic material and UV resistant.

High reflective pigment may reflect as much as 98.9% of the light, resulting in minimal losses. Furthermore such pigments may refract the light due to its rough surface structure. Coatings containing the high reflective pigment can be used for the light curtain, for the light reflecting surface and also for the diffuser plate, whereby different ratios between high reflective pigment and transparent binder is used. A very high ratio is used for the coating of the reflective surface.

Preferably, the lamps are tube-like low pressure mercury discharge lamps, preferably mono phosphor lamps.

In one preferred embodiment tube-like lamps of different colors are located parallel to each other in a plane perpendicular to the diffuser plate. Such group of lamps preferably comprises a blue lamp, a red lamp and a green lamp. By mixing these three colors a large variety of colors can be obtained by reducing the intensity of the light shining from one or two lamps. The luminaire may contain one or more of such groups.

Preferably, the green lamp is positioned closest to the light curtain plate, and preferably the blue lamp is positioned farthest from the light curtain plate. It has appeared that by placing the lamps in this order, the lamps are hidden most efficiently and there is no chance that the different colored lamps can be individual seen at the front side op the luminaire.

In one preferred embodiment the distance between the light curtain plate and the lamp positioned closest to the light curtain plate is between one and two times the diameter of the tube of the lamp. Such small distance appeared to be enough and it enables a luminaire having a relative small height, i.e. in a direction perpendicular to the diffuser plate.

In one preferred embodiment the diffuser plate, and side walls extending from the edge of the diffuser plate, and the light curtain plate together form a closed light box, preferably a dust-tight light box. Dust particles and flies and the like at the back side of the diffuser plate can be seen at the front side of the diffuser plate as dark dots. Therefore it is an advantage to keep the back side of the diffuser plate free from dust and the like. Furthermore the closed light box forms a very rigid portion of the diffuser unit, so that the diffuser unit—even when it has large dimensions—can be easily handled. The diffuser plate may have a dimension of a square with a side of 1.2 meter.

In one preferred embodiment the light box is removable connected to a housing containing the lamps, for example by means of resilient clamps, so that the light box can be pulled out of the housing and can be replaced in the housing by pushing it back into the resilient clamps. Thereby the light box can be removed from the housing when, for example, the lamps has to be replaced.

Preferably, the light reflecting surface—reflecting the light from the lamps towards the light curtain plate—is the inner surface of a wall being attached to the light box. By making that wall and the light box one removable component of the luminaire, also sad wall will be removed from the housing when, for example, the lamps has to be replaced. Thereby the reflecting surface will not be touched by hands of the operating personnel.

In one preferred embodiment the light curtain plate has an undulated shape, whereby near the lamp the distance between the flat diffuser plate and the undulated light curtain plate is smaller than further away from the lamp. Thereby the light curtain plate can be bowed around center of lamp, for example with a radius of 900 mm. Thereby the distance between the diffuser plate and the light curtain plate may vary about 12 mm. Such shape of the light curtain plate appeared to improve the equal distribution of the light over the surface of the diffuser plate.

Preferably, the light curtain plate is provided with a coating containing light reflecting pigment, the coating being provided at the side facing the diffuser plate. Especially if the light curtain plate is part of the light box, the coating can not be touched by hand, because it is inside said light box.

In one preferred embodiment the light curtain plate is provided with a coating containing light reflecting pigment, whereby the coating has a varying thickness, the thickness being relative large near the lamp, so that the transparency near the lamps is less then further away from the lamp. Thereby the equal distribution of the light over the surface of the diffuser plate appeared to be improved.

The invention is furthermore related to a ceiling or wall at least partly created by adjacent front sides of luminaires as claimed in any one of the preceding claims.

The invention is also related to a method for lighting an area by means of a luminaire comprising at least two lamps and a light reflecting surface reflecting the light from said lamps. The lamps radiating light with different colors, whereby the intensity of the light shining from a lamp is reduced in order to vary the color of the light shining through a diffuser plate forming the front side of the luminaire. A light curtain plate is located between the lamps and the diffuser plate, the light curtain plate containing light reflecting material.

The invention will be further explained hereinafter by means of a description of an embodiment of a luminaire, in which reference is made to a drawing, in which:

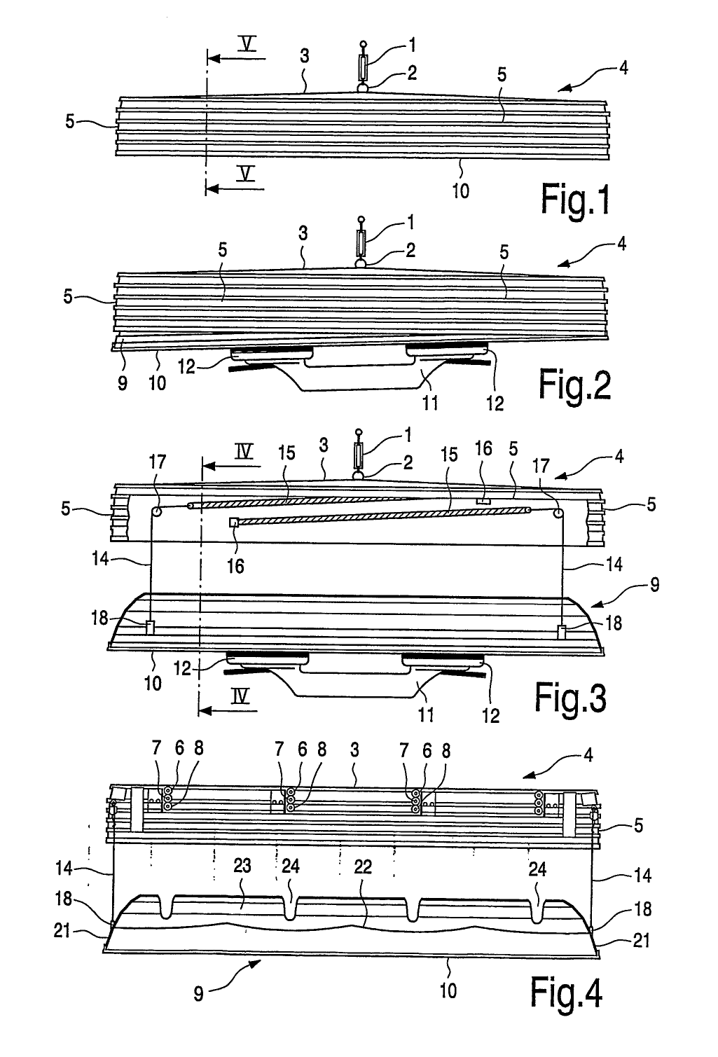

FIG. 1 is a side view of a luminaire;

FIG. 2 shows how to open the luminaire;

FIG. 3 shows an opened luminaire;

FIG. 4 is a sectional view along the line IV-IV in FIG. 3;

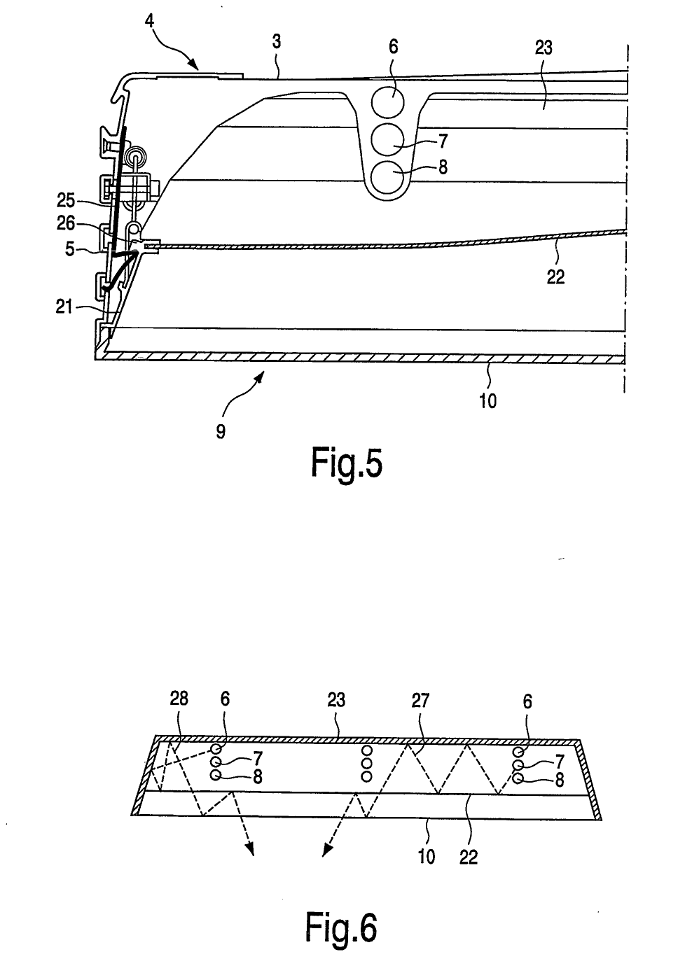

FIG. 5 is a part of the sectional view along the line V-V in FIG. 1; and

FIG. 6 shows reflection of light in the luminaire.

The Figures are merely schematic representations of the embodiment, in which less relevant parts are not shown.

FIG. 1 shows a luminaire suspending by means of a suspension member 1. The suspension member 1 is attached to the luminaire through a connecting element 2 in the center of the upper wall 3 of the housing 4 of the luminaire.

The side walls 5 of the housing 4 of the luminaire are provided with a profile forming horizontal grooves. The housing 4 comprises lamps and forms—together with the lamps and other related parts—the base unit of the luminaire. The base unit can suspend through suspension member 1 or can be fixed at any other manner to a wall or an other object.

Inside said base unit there is a light box 9—as will be explained hereinafter—comprising a diffuser plate 10. Diffuser plate 10 forms the front side of the luminaire, i.e. in FIG. 1 the lower side. The diffuser plate 10 may have a square shape, with a side of for example 1.2 meter.

FIG. 2 shows the removal of the light box 9 from the housing 4. A device 11 provided with a number of suction cups 12 is attached to the diffuser plate 10 after which the diffuser plate 10, and therewith the light box 9, can be pulled downwardly out of the housing 4, whereby resilient clamps 25 (see FIG. 5) in the housing 4 release the light box 9.

FIG. 3 shows the light box 9 suspending underneath the housing 4 through four steel wires 14, whereby a portion of the side wall 5 of the housing 4 is left out to show the steel wires 14 and the helical steel springs 15 tensioning the wires 14. Because the steel wires 14 are spring loaded, the weight of the light box 9 is partly compensated, facilitating the handling of the light box 9.

Each helical spring 15 is attached to the housing 4 through a fixation plate 16. Each helical spring 15 is at its other end attached to the steel wire 14. Steel wire 14 is engaging pulley 17 and at its end attached to light box 9 through fixation plate 18.

FIG. 4 is a sectional view of the light box 9 suspending underneath the base unit comprising housing 4. The base unit furthermore comprises four groups of three tube-like fluorescent lamps 6,7,8. Each group includes three lamps of different colors above each other: blue lamp 6, red lamp 7 and green lamp 8. So, the light shining from the luminaire originates from lamps 6,7,8 with different colors. However, the different colors should be mixed in order to achieve only one color of the light shining from the luminaire and to avoid the appearance of different colors on the surface of the diffuser plate 10.

The color of the light shining from the luminaire can be varied by reducing the intensity of the light shining from one or two lamps 6,7,8 of each group of three lamps. Thereby a wide variety of colors can be achieved by choosing a good combination of base colors such as blue, red and green.

The lampholders of the lamps 6,7,8 are mounted in the housing 4 of the luminaire, so that the lamps 6,7,8 stay in the housing 4 when the light box 9 is removed from the housing. The housing 4 and lamps 6,7,8 and other related parts form the base unit of the luminaire.

The light box 9—as shown in sectional view in FIG. 4—comprises diffuser plate 10, side walls 21 extending from the edge of the diffuser plate 10 and a light curtain plate 22 being positioned substantially parallel to the diffuser plate 10 and being connected to the diffuser plate 10 through said side walls 21. The diffuser plate 10 is of plastic material and welded to the side walls 21, also of plastic material. Side walls 21 are welded to the light curtain plate 22, which plate is also of plastic material. Thereby a dust-tight light box 9 is created.

The light curtain plate 22 is not flat, but curved around the lamps 6,7,8 so that the distance between the flat diffuser plate 10 and the light curtain plate 22 is smaller near the lamps 6,7,8 then at more distance from the lamps. In fact, the light curtain plate 22 is undulated, as is shown in the sectional view of FIG. 4.

The light curtain plate 22 is made of transparent plastic material and is at its lower side (inside the light box 9) provided with a coating comprising a light reflecting pigment in a transparent binder. Therefore, light reaching the surface of the light curtain plate 22 will be partly transmitted and partly reflected, in a ratio depending of the ratio between the quantity of light reflecting pigment and the quantity of binder, and furthermore depending of the thickness of the layer formed by the coating.

The thickness of the layer formed by the coating near the lamps 6,7,8 is larger then further away from the lamps, so that near the lamps 6,7,8 relative more light is reflected then further away from the lamps.

The light box 9 is provided with a wall 23 having a light reflecting surface at its side facing the light box 9. The wall 23 have recesses 24 for accommodating the lamps 6,7,8 when the luminaire is assembled. Thereby the lamps 6,7,8 are surrounded by the light curtain plate 22 and the wall 23, except for the area above the lamps. The reflecting surface mainly directs the light radiation from the lamps 6,7,8 towards the light curtain plate 22.

The light reflecting surface of wall 23 is created by applying a coating on it, having a high ratio of high reflective pigment relative to the transparent binder.

FIG. 5 is a part of a sectional view along the line V-V in FIG. 1. Light box 9 is located inside the housing 4 and is fixed in its operational position by a number of steel springs 25. Each steel spring 25 is attached to the side wall 5 of housing 4 and engages a rib 26 of the side wall 21 of the light box 9. Because the steel springs 25 are resilient it will deform sufficiently to release the light box 9 when the light box is pulled downwardly. And when the light box 9 is moved back into the housing 4, the steel spring 25 will engage with the rib 26, so that a sufficient strong fixation of the light box 9 in the housing 4 is achieved.

FIG. 6 shows schematically the reflection of light in the luminaire. Three groups of three tube-like lamps 6,7,8 are present and each lamp is radiating light in all directions. Furthermore there is diffuser plate 10, a curtain plate 22, and a wall 23 having a light reflecting inner surface.

The light reflecting surface of wall 23 is created by a coating comprising a relative large quantity of high reflecting pigments having a rough surface structure, so that the light shining on the surface is not only reflected to a high degree, for example for 98.9%, but is also refracted.

The light curtain plate 22 is a transparent plastic plate provided with a similar coating comprising high reflective pigments and a transparent binder. That coating comprises less pigments, so that only a portion of the light reaching the light curtain plate 22 is reflected and the other portion is transmitted through the plate 22. The coating is able to be sprayed in different degrees of transparency.

Diffuser plate 10 is also coated to complete the visual effect of a homogeneous distribution of the light without any color differences. Thereby a portion of the light is reflecting.

A portion of the light radiated by the lamps 6,7,8 is directed to the light reflecting inner surface of wall 23, and another portion is directed to the light curtain plate 22. In FIG. 6 are two light beams 27,28 represented by dotted lines. Light beam 27 is radiated by lamp 7 and directed to the light curtain plate 22. Beam 27 is twice reflected by light curtain plate 22 and wall 23 and then transmitted by light curtain plate 22, so that beam 27 reached the diffuser plate 10. Diffuser plate 10 reflects beam 27 once and after reflection against the light curtain plate 22 beam 27 is transmitted by the diffuser plate 10, so that it is part of the light shining from the luminaire.

Light beam 28 also reflects a number of times against the inner surface of wall 23, the light curtain plate 22 and the diffuser plate 10 before it leaves the luminaire. Each reflection results in defraction of the beam, whereby the angle of incidence may be different from the angle of reflection, being disproportionally shown in FIG. 6.

The lamps 6,7,8 shine different colors: lamp 6 is blue, lamp 7 is red and lamp 8 is green. The different colors should be mixed to obtain one color of light shining from the luminaire. The color mix is based on the multiple reflections within the luminaire. The color mix is based on the multiple reflections within the luminaire. By reflecting the light a number of times, the red, green and blue light becomes scattered and mixed to homogeneous white or colored light. Due to the high reflective coatings used in the luminaire, the losses of light are minimized.

The embodiment of the luminaires as described above is merely an example; a great many other embodiments are possible.

1. Luminaire comprising holders for at least two lamps (6,7,8) and a light reflecting surface (23) for reflecting the light from said lamps (6,7,8), the lamps may radiate light with different colors, whereby the intensity of the light shining from a lamp (6,7,8) can be reduced in order to vary the color of the light shining through a diffuser plate (10) forming the front side of the luminaire, characterized by a light curtain plate (22) located between the location of the lamps (6,7,8) and the diffuser plate (10), the light curtain plate (22) containing light reflecting material.

2. Luminaire as claimed in claim 1, characterized in that the luminaire comprises at least two lamps (6,7,8) of different color.

3. Luminaire as claimed in claim 1, characterized in that the light curtain plate (22) is substantial parallel to the diffuser plate (10).

4. Luminaire as claimed in claim 1, characterized in that the light curtain plate (22) is transparent and provided with a coating containing high reflecting pigment.

5. Luminaire as claimed in claim 1, characterized in that the lamps (6,7,8) are tube-like low pressure mercury discharge lamps, preferably mono phosphor lamps.

6. Luminaire as claimed in claim 1, characterized in that tube-like lamps (6,7,8) of different colors are located parallel to each other in a plane perpendicular to the diffuser plate (10).

7. Luminaire as claimed in claim 1, characterized by one or more groups of a blue lamp (6), a red lamp (7) and a green lamp (8).

8. Luminaire as claimed in claim 7, characterized in that the green lamp (8) is positioned closest to the light curtain plate (22), and preferably the blue lamp (6) is positioned farthest from the light curtain plate (22).

9. Luminaire as claimed in claim 1, characterized in that the distance between the light curtain plate (22) and the lamp (8) positioned closest to the light curtain plate (22) is between one and two times the diameter of the tube of the lamp (8).

10. Luminaire as claimed in claim 1, characterized in that the diffuser plate (10), side walls (21) extending from the edge of the diffuser plate (10), and the light curtain plate (22) form a closed light box (9), preferably a dust-tight box light box.

11. Luminaire as claimed in claim 10, characterized in that the light box (9) is removable connected to a housing (4) containing the lamps (6,7,8).

12. Luminaire as claimed in claim 10, characterized in that the light reflecting surface is the inner surface of a wall (23) being attached to the light box (9).

13. Luminaire as claimed in claim 1, characterized in that the light curtain plate (22) has an undulated shape, whereby near the lamp (8) the distance between the flat diffuser plate (10) and the undulated light curtain plate (22) is smaller than further away from the lamp (8).

14. Luminaire as claimed in claim 1 characterized in that the light curtain plate (22) is provided with a coating containing light reflecting pigment, the coating being provided at the side facing the diffuser plate (10).

15. Luminaire as claimed in claim 1, characterized in that the light curtain plate (22) is provided with a coating containing light reflecting pigment, whereby the coating has a varying thickness, the thickness being relative large near the lamp (8).

16. Ceiling or wall at least partly created by adjacent front sides of luminaires as claimed in claim 1.

17. Method for lighting an area by means of a luminaire comprising at least two lamps (6,7,8) and a light reflecting surface (23) reflecting the light from said lamps, the lamps (6,7,8) radiating light with different colors, whereby the intensity of the light shining from a lamp is reduced in order to vary the color of the light shining through a diffuser plate (10) forming the front side of the luminaire, characterized by a light curtain plate (22) located between the lamps and the diffuser plate (10), the light curtain plate (22) containing light reflecting material.
